(19) United States
(12) Patent Application Publication
(10) Pub. No.: US 2025/0348305 A1
(43) Pub. Date: Nov. 13, 2025

(54) POWERSPORTS VEHICLE WITH SERVICE-ORIENTED ARCHITECTURE

(71) Applicant: Polaris Industries Inc., Medina, MN (US)

(72) Inventor: Brian Berg, Medina, MN (US)

(73) Assignee: Polaris Industries Inc., Medina, MN (US)

(21) Appl. No.: 19/206,927

(22) Filed: May 13, 2025

Related U.S. Application Data
(60) Provisional application No. 63/646,144, filed on May 13, 2024.

(51) Int. Cl. G06F 8/65; B60R 16/023

(52) U.S. Cl. CPC G06F 8/65; B60R 16/0232

(57) ABSTRACT

A powersports vehicle with a service-oriented architecture is provided. In example aspects, a vehicle controller connected to a CAN bus performs a discovery process to identify vehicle component controllers on the CAN bus and the capabilities thereof. Based on the discovered capabilities of the vehicle component controllers, the vehicle controller can control communication with the vehicle component controllers to implement vehicle-wide features. For example, the discovery process may enable publish/subscribe and request/response communication between the vehicle controller and the vehicle component controllers. These discovery and communication processes allow for a service-oriented architecture to be implemented over the CAN bus.

### CROSS-REFERENCE TO RELATED APPLICATIONS

The present application claims priority from U.S. Provisional Patent Application No. 63/646,144, filed on May 13, 2024, the disclosure of which is hereby incorporated by reference in its entirety.

### BACKGROUND

Vehicles have a variety of electrical components and controllers used to control operation of the vehicles. For example, the electrical components may implement features for the vehicle. To implement these features on the vehicle, it may be desirable to enable a service-oriented architecture at the vehicle. While SOME/IP (Service-Oriented Middleware over Internet Protocol), a service-oriented architecture specification for communication middleware released by Automotive Open System Architecture (AUTOSAR), supplemented traditional non-diagnostic signal-based electronic control unit (ECU) communication with service-based messaging, SOME/IP only applies to internet protocol (IP) networks. Thus, non-diagnostic feature implementations for vehicles are limited to signal-based communication in controller area networks (CAN).

### SUMMARY

In accordance with aspects of the present disclosure, a powersports vehicle with a service-oriented architecture is provided. In example aspects, a vehicle controller connected to a CAN bus performs a discovery process to identify vehicle component controllers on the CAN bus and the capabilities thereof. Based on the discovered capabilities of the vehicle component controllers, the vehicle controller can control communication with the vehicle component controllers to implement vehicle-wide features. For example, the discovery process may enable publish/subscribe and request/response communication between the vehicle controller and the vehicle component controllers. These discovery and communication processes allow for a service-oriented architecture to be implemented over the CAN bus.

In a first aspect, a powersports vehicle is provided. The powersports vehicle includes a plurality of ground-engaging members, a frame supported by the plurality of ground-engaging members, a controller area network (CAN) bus, and a vehicle controller. The vehicle controller includes at least one processor and a memory storing data instructions. Execution of the data instructions by the at least one processor causes the vehicle controller to perform a discovery process to identify capabilities of a set of vehicle component controllers coupled to the CAN bus, request data from a first vehicle component controller of the set of vehicle component controllers based on the identified capabilities of the first vehicle component controller, receive the data from the first vehicle component controller via the CAN bus, and transmit a request to a second vehicle component controller of the set of vehicle component controllers via the CAN bus in response to receiving the data.

In a second aspect, a method for implementing features of a powersports vehicle is provided. A discovery process is performed to identify capabilities of a set of vehicle component controllers coupled to a controller area network (CAN) bus of the powersports vehicle. Data is requested from a first vehicle component controller of the set of vehicle component controllers based on the identified capabilities of the first vehicle component controller. The data is received from the first vehicle component controller via the CAN bus. In response to receiving the data, a request is transmitted to a second vehicle component controller of the set of vehicle component controllers via the CAN bus.

In a third aspect, a non-transitory computer-readable medium is provided. The computer-readable medium has stored thereon data instructions that, when executed by one or more processors, cause the one or more processors to perform a discovery process to identify capabilities of a set of vehicle component controllers coupled to a controller area network (CAN) bus of a powersports vehicle, request data from a first vehicle component controller of the set of vehicle component controllers based on the identified capabilities of the first vehicle component controller, receive the data from the first vehicle component controller via the CAN bus, and transmit a request to a second vehicle component controller of the set of vehicle component controllers via the CAN bus, in response to receiving the data.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1 illustrates an example of a vehicle.

FIG. 2 illustrates an example block diagram of a vehicle during a discovery process.

FIG. 3 illustrates an example of a capabilities document.

FIG. 4 illustrates a flowchart of an example method for performing a discovery process.

FIG. 5 illustrates an example message flow diagram for performing a discovery process and subsequently communicating with a vehicle component controller.

FIG. 6 illustrates an example message flow diagram for implementing vehicle-wide features.

FIG. 7 illustrates a flowchart of an example method for implementing a vehicle-wide feature.

FIG. 8 illustrates an example block diagram of a vehicle for executing vehicle-wide features.

FIG. 9 illustrates an example block diagram of a vehicle for receiving over-the-air updates.

### DETAILED DESCRIPTION

In accordance with aspects of the present disclosure, a powersports vehicle with a service-oriented architecture is provided. In example aspects, a service-oriented architecture is implemented with a vehicle using Unified Diagnostic Services (UDS) on a controller area network (CAN) bus. Accordingly, a software-defined vehicle (SDV) framework can be realized with the vehicle in a simple, low-cost framework. In examples, existing communication methods and protocols for communicating over a CAN bus in a vehicle are utilized to implement the service-oriented architecture. For example, as described further herein, general services defined in ISO 14229 may be utilized. Similarly, communications such as request-response from ISO 15765, along with its protocol features like transport protocol, may be utilized. Given the popularity of UDS, these communication methods and protocols are already implemented in most electronic control units (ECUs), allowing the framework to be implemented in a variety of vehicles without requiring extensive modifications to the vehicles or components thereof.

As described further herein, in this framework, a vehicle controller (or other on-board computer) can discover other controllers within a vehicle, such as controllers for components of the vehicle, and determine the capabilities associated with the controllers. After discovering the other controllers and the associated features, the vehicle controller can manage communication with the controllers and coordinate the controls to implement more advanced, vehicle-wide features that require actions by multiple controllers.

Further, these discovery and communication processes allow for application programming interfaces (APIs) in programming spaces of the controllers' memories to be created and implemented, allowing developers and manufacturers to easily create vehicle-wide features that require actions by the controllers using system-level software. Additionally, over-the-air (OTA) updates may be used to deploy updates to vehicles remotely, allowing feature development iterations to be readily installed and tested on the vehicle. These also provide additional benefits, such as reusability, modularity, and cost in comparison to traditional automotive soft system feature development. Additionally, by being based on UDS—which is specified over other lower OSI layer protocols, such as IP, the systems and methods described herein allow manufacturers to continue to use UDS and CAN-based systems, rather than requiring a transition to other systems, such as automotive ethernet.

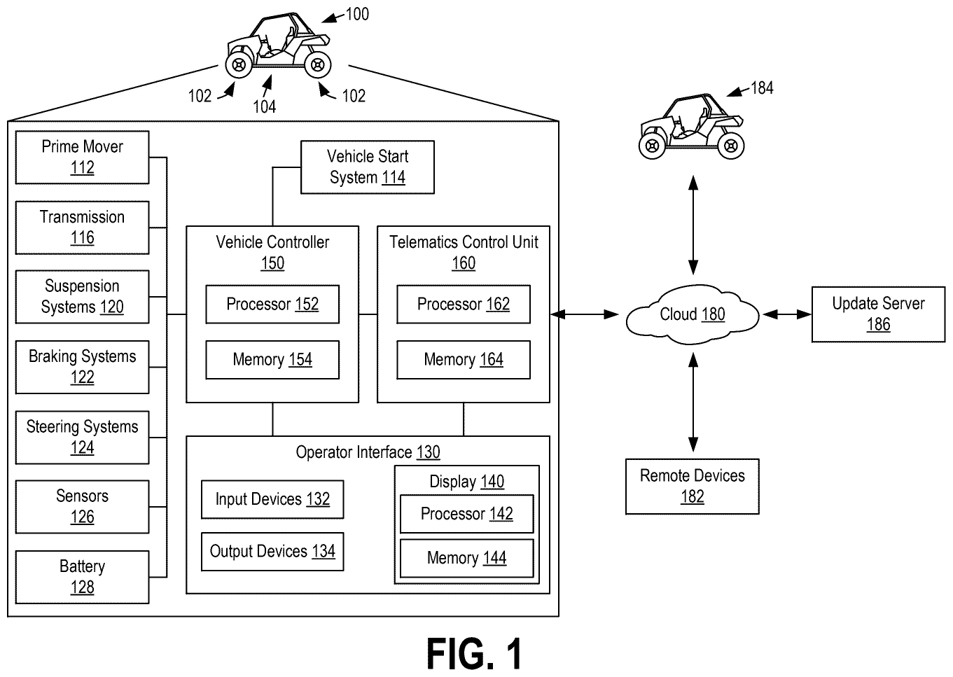

Turning to FIG. 1, an example of a vehicle 100 is provided. In an example, the vehicle 100 is a powersports vehicle, such as a side-by-side off road vehicle. While the illustrated example shows the vehicle 100 as a side-by-side off road vehicle, other vehicles may include similar components, including on-road vehicles, off-road vehicles, aquatic vehicles (e.g., boats and personal watercrafts), or other recreational vehicles. Examples of further vehicle configurations are described in U.S. Pat. Nos. 8,827,028; 10,974,784; 10,981,448; 10,960,941; 11,400,997; 11,427,283; and 11,628,722, the disclosures of which are expressly incorporated by reference herein.

The vehicle 100 includes a plurality of ground engaging members 102. Exemplary ground engaging members include skis, endless tracks, wheels, and other suitable devices which support the vehicle 100 relative to the ground. The vehicle 100 further includes a frame 104 supported by the plurality of ground engaging members 102. In one example, the frame 104 includes cast portions, weldments, tubular components or a combination thereof. In one example, the frame 104 is a rigid frame. In one example, the frame 104 has at least two sections which are moveable relative to each other.

An operator support is supported by the frame 104. Exemplary operator supports include straddle seats, bench seats, bucket seats, and other suitable support members. In addition to the operator support, the vehicle 100 may further include a passenger support. Exemplary passenger supports include straddle seats, bench seats, bucket seats, and other suitable support members.

A power system is supported by the frame 104 and illustratively includes a prime mover 112 and a transmission 116. The power system provides the motive force and communicates the same to at least one of the ground engagement members 102 to power movement of the vehicle 100.

Exemplary prime movers 112 include internal combustion engines, two stroke internal combustion engines, four stroke internal combustion engines, diesel engines, electric motors, hybrid engines, and other suitable sources of motive force. To start the prime mover 112, a vehicle start system 114 is provided. The type of vehicle start system 114 depends on the type of prime mover 112 used. In one example, the prime mover 112 is an internal combustion engine and the vehicle start system 114 is one of a pull start system and an electric start system. In one example, the prime mover 112 is an electric motor and the vehicle start system 114 is a switch system which electrically couples one or more batteries to the electric motor. In examples, vehicle start system 114 includes a key (or key fob).

The transmission 116 is coupled to prime mover 112. In examples, the transmission 116 includes a shiftable transmission and a continuously variable transmission (“CVT”). In one arrangement, the CVT is coupled to the prime mover 112 and the shiftable transmission is in turn coupled to the CVT. In one example, the shiftable transmission includes a forward high setting, a forward low setting, a neutral setting, a park setting, and a reverse setting. Exemplary CVTs are disclosed in U.S. Pat. Nos. 6,176,796; 6,860,826; and 6,938,508, the disclosures of which are expressly incorporated by reference herein. The transmission 116 is further coupled to at least one differential (not shown) which is in turn coupled to at least one ground engaging member 102.

The vehicle 100 further includes a plurality of suspension systems 120 which couple the ground engaging members 102 to the frame 104. Exemplary suspension systems are disclosed in U.S. Pat. Nos. 10,987,987; 10,987,989; 11,110,913; 11,124,036; and 11,904,648, and U.S. patent application Ser. No. 17/325,062, filed on May 19, 2021, and entitled “Systems and Methods of Adjustable Suspensions for Off-Road Recreational Vehicles,” the entire disclosures of which are expressly incorporated by reference herein.

The vehicle 100 further includes a braking system 122. In one example, the braking system 122 includes anti-lock brakes.

The vehicle 100 further includes a steering system 124. The steering system 124 is coupled to at least one of the ground engagement members 102 to direct the vehicle 100.

The vehicle 100 further includes a plurality of sensors 126 which monitor various characteristics of the vehicle 100 and a battery 128 which provides power to various components of the vehicle 100. Example sensors include, but are not limited to, a Global Positioning System (GPS) sensor, an accelerometer, a conductive ball and socket, an ambient temperature sensor, an image sensor, a microphone, or a light detection and ranging (LIDAR) sensor, among other examples.

Further, the vehicle 100 includes a vehicle controller 150 having at least one processor 152 and at least one associated memory 154. The vehicle controller 150 provides the electronic control of the various components of the vehicle 100. Further, the vehicle controller 150 is operatively coupled to the plurality of sensors 126 which monitor various parameters of the vehicle 100 or the environment surrounding the vehicle 100. The vehicle controller 150 performs certain operations to control one or more subsystems of other vehicle components, such as one or more of a fuel system, an air handling system, the CVT, the shiftable transmission, the prime mover 112, suspension systems 120, and other systems. As described further herein, the vehicle controller 150 may coordinate these vehicle subsystems to enable vehicle-wide features. In examples, the vehicle controller 150 may communicate with these subsystems over a CAN bus.

In certain examples, the vehicle controller 150 forms a portion of a processing subsystem including one or more computing devices having memory, processing, and communication hardware. The vehicle controller 150 may be a single device or a distributed device, and the functions of the vehicle controller 150 may be performed by hardware and/or as computer instructions on a non-transitory computer readable storage medium, such as memory 154.

The at least one processor 152 may include one or more processing units, or programmable circuits. A processing unit is a physical device or article of manufacture comprising one or more integrated circuits that selectively execute software instructions. In various examples, the at least one processor 152 is implemented in various ways. For example, the at least one processor 152 can be implemented as one or more physical or logical processing cores. In another example, the at least one processor 152 can include one or more separate microprocessors. In yet another example, the at least one processor 152 can include an application-specific integrated circuit (ASIC) that provides specific functionality. In yet another example, the at least one processor 152 provides specific functionality by using an ASIC and by executing computer-executable instructions.

The memory 154 can be implemented using various types of computer storage media, and generally includes at least some tangible media. In some examples, the memory 154 is implemented using entirely non-transitory media. In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The vehicle controller 150 also interacts with an operator interface 130 which includes at least one input device 132 and at least one output device 134. Exemplary input devices 132 include levers, buttons, switches, soft keys, and other suitable input devices. Exemplary output devices 134 include lights, displays, audio devices, tactile devices, and other suitable output devices. An operator may signal to the vehicle controller 150 to alter the operation of one or more systems of vehicle 100 through the input devices 132.

The operator interface 130 further includes a display 140. The display 140 includes at least one processor 142 and an associated memory 144. The at least one processor 142 and the memory 144 may be similar to the at least one processor 152 and the memory 154 described above. In examples, the operator interface 130 with the display 140 is an in-vehicle infotainment (IVI) system. In one example, the display 140 is a touch screen display and operator interface 130 interprets various types of touches to the touch screen display as inputs and controls the content displayed on touch screen display.

The vehicle 100 further includes a telematics control unit (TCU) 160. The telematics control unit 160 may receive information and/or instructions from the cloud 180 for use by the vehicle controller 150 and may provide information and/or instructions to remote devices 182 or other vehicles 184 through the cloud 180. Further, the information stored in the cloud 180 may be retrieved through a web interface associated with the vehicle 100. The telematics control unit 160 is capable of waking up periodically while vehicle 100 is not running to communicate with cloud 180, remote devices 182, and/or other vehicles 184. The telematics control unit 160 may have security features enabled for remote notification for a theft alert when the vehicle 100 is not running. In examples, the telematics control unit 160, also referred to as a connectivity circuit, is powered by the battery 128 of the vehicle 100. The telematics control unit 160 may include at least one processor 162 and a memory 164, which may be similar to the at least one processor 152 and the memory 154 described above. As described further herein, the telematics control unit 160 may receive over-the-air updates from an update server 186. For example, the updates may be installed at the vehicle 100 to enable vehicle-wide features.

As described briefly above, a service-oriented architecture may be implemented at the vehicle 100 using Unified Diagnostic Services (UDS) on a CAN bus that connects the vehicle controller 150 with other components and subsystems of the vehicle 100. As an initial step to enable the service-oriented architecture, a discovery process may be performed so that the vehicle controller 150 can determine the capabilities of the subsystems of the vehicle.

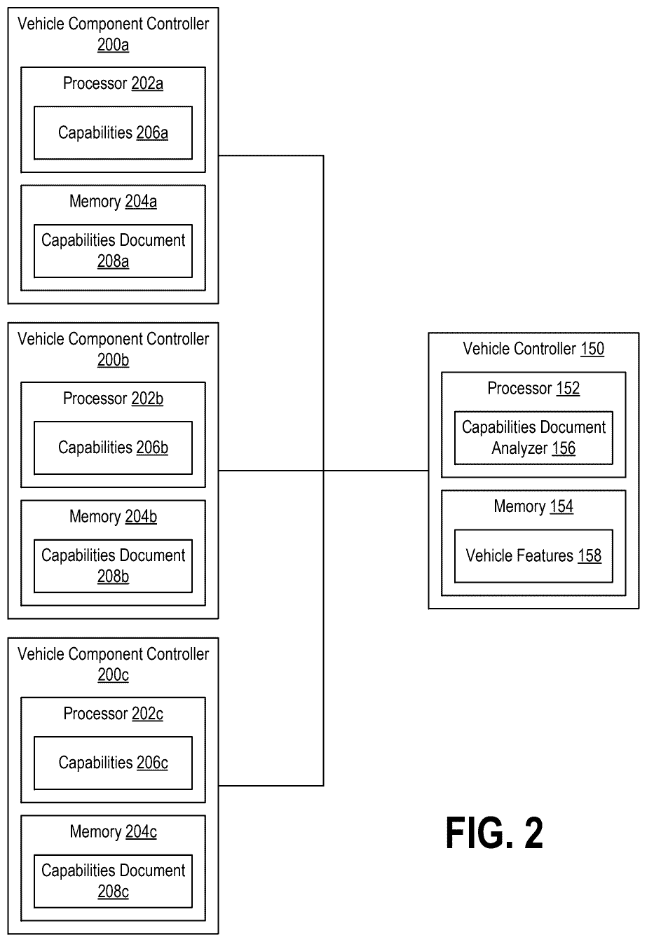

FIG. 2 illustrates an example block diagram of a vehicle controller 150 during a discovery process. As described above, the vehicle controller may include a processor 152 and a memory 154. In the illustrated example, the vehicle controller 150 is connected to one or more vehicle component controllers 200, each of which have at least one processor 202 and a memory 204 similar to the processor 152 and the memory 154 described above. Each of the vehicle component controllers 200 may be capable of performing one or more capabilities 206.

In examples, the vehicle component controllers 200 may control a component of subsystem of the vehicle 100, such as one or more of a fuel system, an air handling system, the CVT, the shiftable transmission, the prime mover 112, suspension systems 120, and other systems, as described above. Examples of vehicle component controllers 200 include an engine control module, a power train control module, a transmission control module, an anti-lock braking system controller, an electronic stability control, an airbag control unit, an advanced driver assistance system, a body control module, a suspension control module, a central control module, a telematics system, an in-vehicle infotainment system, a tire pressure monitoring system, and an event data recorder. In other examples, the vehicle component controllers 200 may control other components or subsystems of the vehicle 100.

During the discovery process, the vehicle controller 150 may discover the capabilities 206 of each of the vehicle component controllers 200 and the corresponding vehicle components and subsystems. In the illustrated example, each vehicle component controller 200 may maintain or otherwise be associated with a capabilities document 208. The capabilities document 208 may define the capabilities 206 of the vehicle component controller and the associated component or subsystem.

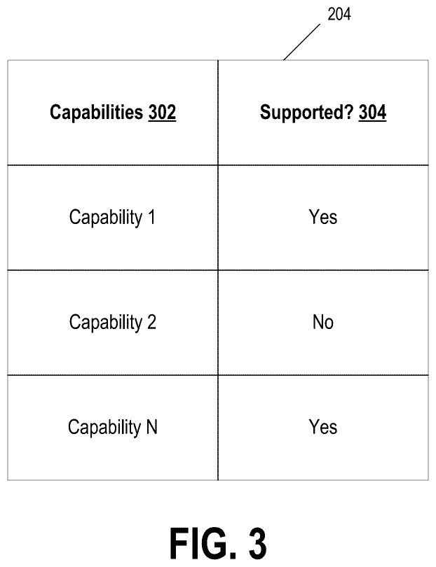

FIG. 3 illustrates an example of a capabilities document 208. In an example, the capabilities document 208 includes a list of capabilities 302 that may be supported by the associated vehicle component controller 200 and corresponding vehicle components and subsystems. For example, if the vehicle component controller 200 with which the capabilities document is associated is an engine control module, the capabilities 302 may include functions associated with engine performance, fuel injection, ignition timing, emissions, and the like.

For each of the capabilities 302, the capabilities document 208 includes an indication 304 of whether the capability 302 is supported or not. For example, in the illustrated example, a first capability may be supported by the corresponding vehicle component controller 200, but a second capability may not be supported by the corresponding vehicle component controller 200. In an example, a capability 302 may not be supported because the vehicle is not configured to perform the capability 302. In another example, the capability 302 may not be supported because the capability 302 is part of a subscription package to which a driver of the vehicle has not subscribed. In other examples, there may be additional or alternative reasons why a capability 302 may not be supported.

In an example, the capabilities document 208 is an SAE J1979-DA document. The SAE J1979-DA document specifies the diagnostic data which may be required to be supported by a vehicle and external test equipment for diagnostic purposes which pertain to vehicle emission-related data.

While the SAE J1979-DA document may be designed for use with diagnostic systems, the data maintained thereon may be used to discover the supported capabilities of a vehicle component controller 200. In an example, the SAE J1979-DA document includes supported coding bits that identify whether a capability is supported—e.g., a “1” may indicate that a capability is supported, and a “0” may indicate that a capability is not supported. By using data identifiers to read the relevant supported coding bits, the capabilities of a vehicle component controller 200 can be determined.

In another example, the capabilities document 208 may be an SAE J2012 document. SAE J2012 is a standard from the Society of Automotive Engineers (SAE) that defines standardized diagnostic trouble codes (DTCs) for on-board diagnostic (OBD) systems in vehicle. These diagnostic trouble codes may be used to report malfunctions detected by the on-board diagnostic systems. The J2012 standard also specifies ranges for vehicle manufacturer specific diagnostic trouble codes.

In a further example, the capabilities document 208 may be an ISO 27145-2 document. ISO 27145 is a standard which defines communications for on-board diagnostic systems. As described further herein, an annex to the ISO 27145-2 standard may define the encoding of the supported coding dataIdentifiers.

Returning to FIG. 2, the vehicle controller 150 may use the capabilities documents 208 of each of the vehicle component controllers 200 to determine the capabilities of the vehicle 100. The vehicle controller 150 may include in the processor 152 thereof a capabilities document analyzer 156. The capabilities document analyzer 156 may determine the capabilities 206 of each vehicle component controller 200 using the corresponding capabilities documents 208. For example, the vehicle component controllers 200 may transmit the capabilities documents 208 to the vehicle controller 150 to be processed by the capabilities document analyzer 156. The capabilities document analyzer 156 may store in the memory 154 of the vehicle controller 150 a list of the capabilities of the vehicle 100 based on the capabilities 206 of the vehicle component controllers 200. These capabilities may be used by the vehicle controller 150 to implement one or more vehicle features 158.

In alternative examples, rather than the vehicle component controllers 200 transmitting the capabilities document 208 to the vehicle controller 150 for processing by the capabilities document analyzer 156, the capabilities document analyzer 156 may request specific data from the vehicle component controller 200 about the capabilities document 208. For example, the capabilities document analyzer 156 may request a specific range of data included in the capabilities document 208. In an example, the vehicle controller 150 may store in the memory 154 a format of the capabilities documents 208 so the vehicle controller 150 knows what data to request from the vehicle component controllers 200. In another example, the capabilities document analyzer 156 may request for the vehicle component controller 200 to send a list of each supported capability 206 of the vehicle component controller 200. In this example, the vehicle component controller 200 may read the corresponding capabilities document 208 and return a list of the supported capabilities 206.

In an example, the vehicle controller 150 may perform the discovery process each time the vehicle 100 starts up. In some examples, the vehicle controller 150 may additionally or alternatively perform the discovery process when a vehicle component controller 200 turns on or is plugged into the system (e.g., when a vehicle accessory is plugged in).

In an example, as described above, the capabilities documents 208 may be SAE J1979-DA documents. In these examples, the vehicle controller 150 may determine capabilities of the vehicle by communicating with the vehicle component controllers 200 to determine the capabilities 206 thereof using the ISO 14429-1 communication protocol—i.e., the UDS communication protocol. In these examples, the vehicle controller 150 may act as a client and the vehicle component controllers 200 may act as servers.

The vehicle controller 150 may send out one or more ReadDataByIdentifier (Svc 0x19) requests to each of the vehicle component controllers 200. In examples, these requests include the retrieval of the ISO 14229-1 software version dataIdentifier (e.g., DID 0xF195) as well as the supported coding dataIdentifiers (DIDs) in one or more On-Board Specified dataIdentifier (OBS-DID) ranges.

Table A.1 of Annex A of ISO 27145-2, which is hereby incorporated by reference in its entirety, defines the encoding of the supported coding DIDs with lower bytes 0x00, 0x20, 0x40, 0x60, 0x80, 0xA0, and 0xC0 to indicate which of the 31 DIDs (that follow each of the listed lower bytes in increasing order—i.e., the OBS-DID range) are supported by the given vehicle component controller 200. As described above, “0” may indicate that the corresponding capability 206 is not supported, and a “1” may indicate that the corresponding capability 206 is supported.

In other examples, the range of 32 DIDs that follow the OBS-DID range may provide the metadata of the OBS-DIDs used by the vehicle controller 150 to determine the capabilities 206 of the corresponding vehicle component controller 200. For example, a DID with lower byte 0xC1 may contain the metadata corresponding to an OBS-DID with lower byte 0xA1. In another example, a DID with lower byte 0xDF may contain the metadata corresponding to an OBS-DID with lower byte 0xBF. In examples, this metadata may be supplemental information in additional to that returned by a ReadScalingDataByIdentifier (Svc 0x24) request.

To reduce bus traffic, the vehicle controller 150 may initially send the read requests using functional addressing—e.g., for only single frame data. For vehicle component controllers 200 that start up after the initial request, the vehicle controller 150 may send physically address requests directly to those vehicle component controllers 200, which the vehicle controller 150 may detect via Address Claim messages that are broadcasted on the bus when the vehicle component controllers 200 start up. In examples, the Address Claim messages may be leveraged from the J1939-81 protocol.

The software version DID 0xF195 may be used by the vehicle controller 150 to determine if the capabilities 206 of the vehicle component controller 200 have been changed after reflashing. In an example, the vehicle controller 150 does not have to ask for the capabilities 206 of a vehicle component controller 200 when the vehicle controller 150 determines from the software version DID that the capabilities 206 have not been updated. In cases in which multiple vehicle component controllers 200 are updated at the same time on a bus running at baud rates lower than 1 Mbps, a system initialization phase may be used prior to vehicle operation (e.g., post-reflash) to perform the complete discovery process with the newly updated vehicle component controllers 200.

After the vehicle controller 150 receives the supported coding dataRecords, the vehicle controller 150 then knows which of the dataIdentifiers in the one or more OBS-DID ranges contain the definitions of the capabilities 206 for each of the vehicle component controllers 200, and any signal data corresponding to those capabilities 206. In an example, the capabilities 206 can be defined, and thus identified, via the OBS-DID ranges according to the type, scaling, units, and other similar characteristics of the data within the dataRecord which is access by requesting the ReadScalingDataByIdentifier (Svc 0x24) corresponding to the data stored in the OBS-DID range corresponding to each capability 206. In another example, the capabilities 206 can be defined, and thus identified, via the OBS-DID ranges according to data stored in the OBS metadata DID that corresponds to each capability DID accessed via ReadDataByIdentifier. In an example, the metadata DIDs may consist of a textual (e.g., ASCII) label or description and correspond to value table DIDs corresponding to Feature Enable Memory Object Write (FEMOW) values. In a further example, the capabilities 206 can be defined, and thus identified, via the OBS-DID ranges according to a hash (e.g., CRC32) of the label DIDs described in the previous example returned by the vehicle component controller 200 via ReadDataByIdentifier of a DID designated for the OBS-DID range. In another example, the capabilities 206 can be defined, and thus identified, via the OBS-DID ranges according to a Coding DID, either individually or by specifying multiple dataIdentifiers in each Svc 0x22 request by taking advantage of those capabilities of Svc 0x22.

By the end of the discovery process, the vehicle controller 150 may have the service, signal, and event information, along with other similar information, from the vehicle component controllers 200 in order to collect and subscribe to any run-time information from the vehicle component controllers 200, as described further herein. This may allow the vehicle controller 150 to implement a given feature that it was designed for, either originally or updated to support (e.g., via over-the-air updates, as described further herein).

For vehicle component controllers 200 that do not support the discovery process but are known a priori to support capabilities 206 (according to their NAME, ECUID, source address, etc.), the vehicle controller 150 may assume default services, signals, events, and other similar characteristics in order to communicate with the vehicle component controller 200 for the vehicle controller 150 to implement the vehicle features 158, as well as other functions and applications.

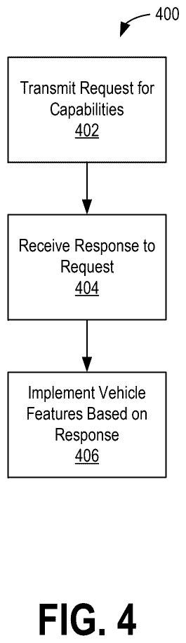

FIG. 4 illustrates a flowchart of an example method 400 for performing a vehicle capabilities discovery process. In the illustrated example, the method 400 includes operations 402, 404, 406. In an example, the method 400 may be performed by a vehicle controller, such as the vehicle controller 150 described above.

The operation 402 includes transmitting a request for capabilities. In an example, the request may be transmitted to one or more vehicle component controllers. Each of the vehicle component controllers may have one or more capabilities or services that it is configured to provide. In an example, the request may include a ReadDataByIdentifier request to retrieve a software version dataIdentifier as well as supported coding dataIdentifiers, as described above. In an example, a vehicle controller transmits the request for capabilities to the one or more vehicle component controllers. In an example, the request is transmitted when the vehicle in which the vehicle controller and the vehicle component controllers are included starts up.

The operation 404 includes receiving one or more responses to the request for capabilities. In an example, each of the one or more vehicle component controllers may respond to the request for capabilities. In examples, each response is based on a capabilities document maintained by the corresponding vehicle component controller. For example, as described above, the capabilities document may include an SAE J1979-DA document, as described above. In an example, the response may include data in the capabilities document that was identified by the dataIdentifiers included in the request—i.e., the capabilities of the vehicle component controller. In another example, the response may include the capabilities document, or a portion thereof. The vehicle controller may then analyze the capabilities document to determine the capabilities of the corresponding vehicle component controller.

The operation 406 includes implementing one or more vehicle features based on the capabilities of the one or more vehicle component controllers. As described above, using the information from the response received during the operation 404, the vehicle controller may collect and subscribe to run-time information from the one or more vehicle component controllers to implement a given feature.

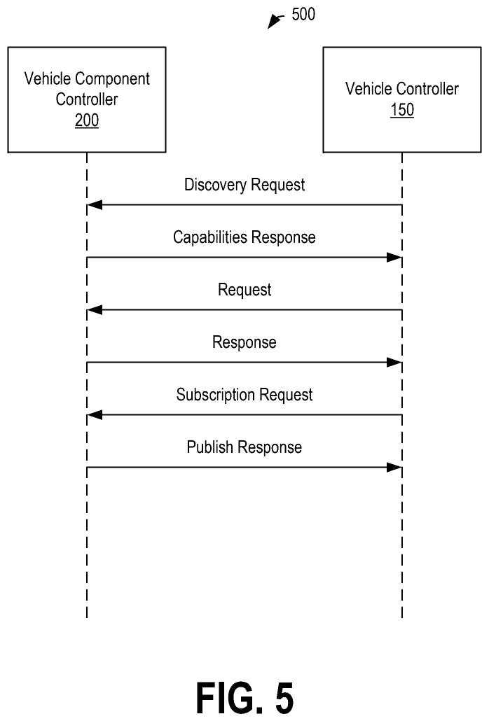

FIG. 5 illustrates a message flow diagram 500 for performing a discovery process. In the illustrated example, the message flow diagram 500 includes communications between a vehicle controller 150 and a vehicle component controller 200. As described above, the communications between the vehicle controller 150 and the vehicle component controller 200 may be made over a CAN bus.

The vehicle controller 150 may send a discovery request to the vehicle component controller 200. In an example, the discovery request may include a ReadDataByIdentifier request to retrieve a software version dataIdentifier and one or more supported coding dataIdentifiers, as described above. The vehicle component controller 200 may respond to the discovery request, such as by providing the data requested based on the dataIdentifiers in the discovery request. As described above, the vehicle controller 150 may make the discovery request at vehicle start-up. In other examples, the vehicle controller 150 may make the discovery request when the vehicle component controller 200 first comes on the CAN bus. For example, if the vehicle component controller 200 is associated with a CAN bus accessory, the vehicle controller 150 may make the discovery request when the CAN bus accessory is plugged in.

As described above, after the discovery process is accomplished, the vehicle controller 150 may have the information needed to communicate with the vehicle component controller 200. In a first example, a request/response communication method may be used. In the request/response method, the vehicle controller 150 may send a request to the vehicle component controller 200 to notify the vehicle component controller 200 about data of the vehicle controller 150, to trigger actions by the vehicle component controller 200, or to make other requests of the vehicle component controller 200 according to the implementation of a vehicle feature. The vehicle component controller 200 may similarly transmit requests to the vehicle controller 150.

After receiving the request, the vehicle component controller 200 may respond to the request accordingly. For example, the vehicle component controller 200 may perform an action specified in the request and then respond to indicate that the action was performed. The vehicle controller 150 may similarly respond to requests from the vehicle component controller 200.

In an example, such as a “thin API” case, a request from the vehicle controller 150 may include a request to set switches (i.e., flags via Boolean logic) in the vehicle component controller 200 as a notification of state, configuration, changes, or other similar events. In some examples, the switches are used in the vehicle component controller 200 to trigger further actions by the vehicle component controller 200. In some examples, in addition to or alternative to setting Boolean values, the request may be used to set a remote parameter (e.g., a dataIdentifier) to a value as expected by the vehicle component controller 200 (e.g., according to the information discovered during the discovery process).

In another example, a publish/subscribe communication method may be used. In the publish/subscribe communication method, the vehicle controller 150 may subscribe to data corresponding to each feature it is responsible for coordinating. In an example, the vehicle controller 150 may send a subscription request to the vehicle component controller 200 to subscribe to data from the vehicle component controller 200. In other examples, the vehicle component controller 200 may similarly send a subscription request with the vehicle controller 150. Based on the subscription request, the vehicle component controller 200 may transmit updates to the vehicle controller 150 based on the subscription request. The vehicle controller 150 may similarly respond to subscription requests from the vehicle component controller 200.

In an example, the subscription request may include a request for periodic updates. For example, when the vehicle controller 150 makes a request for periodic updates from the vehicle component controller 200, the vehicle component controller 200 may send a message to the vehicle controller 150 at the periodic interval specified in the subscription request. In an example, the vehicle controller 150 transmits a ReadDataByPeriodicIdentifier request to the vehicle component controller 200 to request the vehicle component controller 200 to broadcast feature data periodically.

In another example, the subscription request may include a request for an update at the occurrence of an event. For example, the vehicle component controller 200 may send an update when a state of a component managed by the vehicle component controller 200 changes. In an example, the vehicle controller 150 transmits a ResponseOnEvent request to the vehicle component controller 200 to launch a service based upon event conditions specified in the ResponseOnEvent service parameters.

While the above describes two example methods for communication between the vehicle controller 150 and the vehicle component controller 200 (publish/subscribe and request/response), in other examples, additional or alternative communication methods may be employed by the vehicle controller 150 and the vehicle component controller 200.

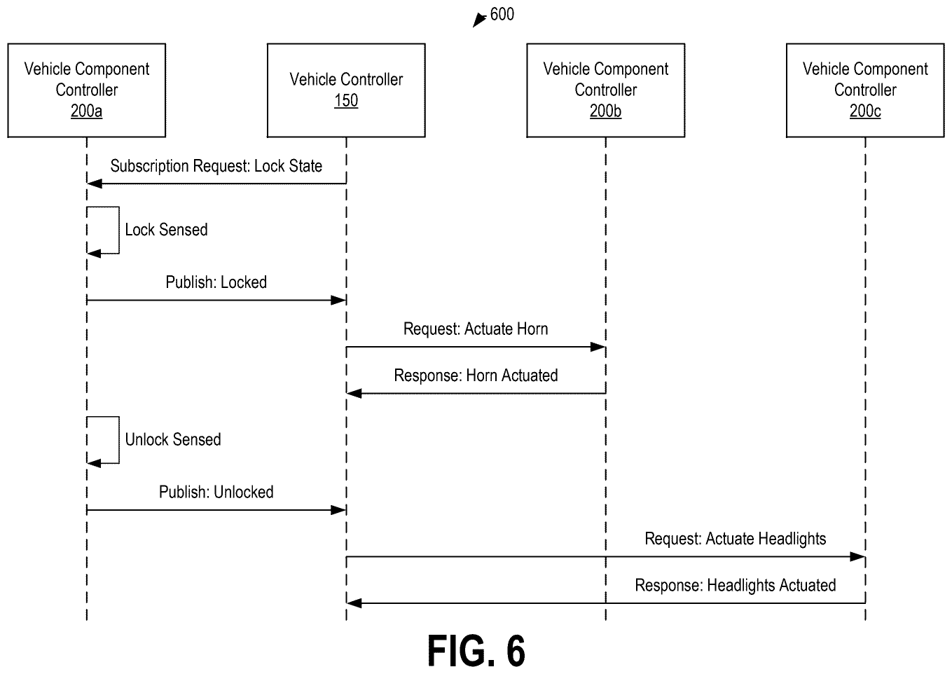

Based on the communications between the vehicle controller 150 and the vehicle component controllers 200, the vehicle controller 150 may coordinate the actions of the vehicle component controllers to enable execution of vehicle features. FIG. 6 illustrates a message flow diagram 600 for executing a vehicle feature based on communication between a vehicle controller 150 and a plurality of vehicle component controllers 200. As described above, the communications between the vehicle controller 150 and the vehicle component controllers 200 may be made over a CAN bus. In the illustrated example, the features implemented may include a remote lock and a vehicle finder.

In the illustrated example, the vehicle controller 150 sends a subscription request to a first vehicle component controller 200a to receive updates based on a change in the lock state of the vehicle. In this example, the first vehicle component controller 200a may control the locks of the vehicle. As described above, the subscription request may include a ResponseOnEvent request in which the specified event is a change in the lock state. In an example, during the discovery process described above, the vehicle controller 150 may have discovered Boolean valued DIDs corresponding to lock and unlock. Accordingly, the subscription request the to those DIDs through a ResponseOnEvent request to trigger a ReadDataByIdentifier response of those Boolean values whenever they change.

When the first vehicle component controller 200a senses a change in the locks state, the first vehicle component controller 200a may transmit a message to the vehicle controller 150 to inform the vehicle controller 150 that the lock state has changed. The vehicle controller 150 may take an action based on the message from the vehicle component controller. For example, when the first vehicle component controller 200a senses that the vehicle was locked, the first vehicle component controller 200a may send an update to the vehicle controller 150. In response to receiving the update indicating the vehicle was locked, the vehicle controller 150 may actuate a horn of the vehicle. In an example, to actuate the horn, the vehicle controller 150 may send a request to a second vehicle component controller 200b that controls the vehicle's horn. The second vehicle component controller 200b may actuate the horn and send a response to the vehicle controller 150 that the horn was actuated. Similarly, when the first vehicle component controller 200a senses that the vehicle was unlocked, the first vehicle component controller 200a may send an update to the vehicle controller 150. In response to receiving the update indicating that the vehicle was unlocked, the vehicle controller 150 may actuate headlights of the vehicle. In an example, to actuate the headlights, the vehicle controller 150 may send a request to a third vehicle component controller 200c that controls the vehicle's headlights. The third vehicle component controller 200c may actuate the headlights and send a response to the vehicle controller 150 that the headlights were actuated.

In alternative examples, rather than the vehicle controller 150 subscribing to updates about the lock state from the first vehicle component controller 200a, the second vehicle component controller 200b and the third vehicle component controller 200c may subscribe to receive lock state updates from the first vehicle component controller 200a. In these examples, the second vehicle component controller 200b may actuate the horn when the first vehicle component controller 200a sends an update that a lock was sensed without needing the vehicle controller 150 to act as an intermediary. Similarly, the third vehicle component controller 200c may actuate the headlights when the first vehicle component controller 200a sends an update that an unlock was sensed without needing the vehicle controller 150 to act as an intermediary.

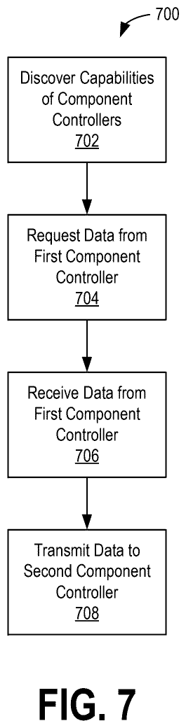

FIG. 7 illustrates a flowchart of a method 700 for implementing vehicle-wide features. In the illustrated example, the method 700 includes operations 702, 704, 706, 708. In an example, the method 700 may be performed by a vehicle controller, such as the vehicle controller 150 described above.

The operation 702 includes discovering capabilities of a plurality of vehicle component controllers. As described above, a discovery request may be sent to each of the plurality of vehicle component controllers. In an example, the discovery request may include one or more ReadDataByIdentifier requests. Each of the plurality of vehicle component controllers may respond to the discovery request based on capabilities documents maintained by the vehicle component controllers—i.e., by providing the data requested in the ReadDataByIdentifier request. Based on the responses to the discovery requests, the capabilities of each vehicle component controller can be determined. Once the capabilities of the vehicle component controllers are determined, vehicle-wide features may be implemented. In an example, a vehicle controller may discover the capabilities of the plurality of vehicle component controllers. As described above, the discovery requests and subsequent responses may be transmitted over a CAN bus.

The operation 704 includes requesting data from a first vehicle component controller. In an example, the request may include a subscription request, such as a request for periodic updates or a request for updates upon the occurrence of an event. In other examples, the request may be a request in the request/response communication method format. In an example, the request may include a subscription request to request updates when a lock state of the vehicle changes. In an example, a vehicle controller sends the request to the first vehicle component controller over a CAN bus.

The operation 706 includes receiving data from the first vehicle component controller. For example, the data may be transmitted from the first vehicle component controller in response to the request sent in the operation 704. For example, if the request in the operation 704 included a subscription request based on the occurrence of an event, the first vehicle component may transmit a response to the request in response to the event occurring. As described above, in an example, the response may include an update of the lock state of the vehicle. In an example, a vehicle controller receives the data from the first vehicle component controller over a CAN bus.

The operation 708 includes transmitting data to a second vehicle component controller. In an example, the data is transmitted to the second vehicle component as a request to perform an action. In examples, the request is transmitted to the second vehicle component in response to receiving the data from the first vehicle component controller. For example, in response to receiving an update that the vehicle was locked from the first vehicle component controller, a request may be transmitted to the second vehicle component controller to actuate a horn of the vehicle. Thus, a remote lock vehicle feature may be enabled by the communications with vehicle component controllers. In an example, a vehicle controller transmits the data to the second vehicle component over a CAN bus.

While the illustrated example, shows communications with a first vehicle component controller and a second vehicle component controller, in other examples, different numbers of vehicle component controllers may be utilized to implement a vehicle-wide feature. For example, with more complex features, more vehicle component controllers may be involved.

Through the discovery process and the communication methods that are enabled because of it (e.g., publish/subscribe and request/response), vehicle-wide features become available over a CAN bus. In some examples, to implement the service interactions for developing a vehicle-wide feature, a programming space in a vehicle component controller's memory may be provided that executes at least part of the feature.

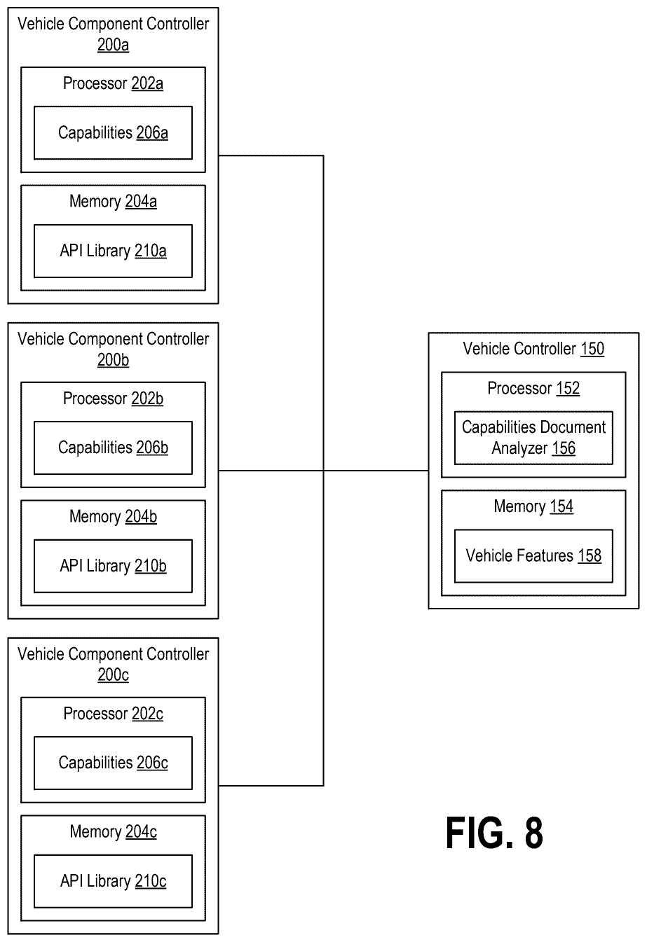

FIG. 8 illustrates an example of vehicle component controllers 200, each having an API library 210 associated therewith. In examples, the API library 210 for a vehicle component controller 200 may be implemented in a programming space of a memory of the vehicle component controller 200. When designing and implementing a feature for a vehicle, a manufacturer or other developer of vehicle features may make calls to APIs of the API libraries 210 of the vehicle component controllers 200 to control actions of the vehicle component controllers 200 or receive information from the vehicle component controllers 200.

In examples, the API libraries 210 allow a standardized programming interface with PDU-level, over-the-wire UDS over CAN commands called in the D-PDU API, which is taken from a subset of the API specified in ISO 22900-2. The APIs of the API libraries 210 may allow for multi-threaded operation, asynchronous communication, event-triggered transmissions, and support for callbacks upon reception of periodic or non-periodic event-triggered services from ISO 14229-1 while supporting network and transport capabilities from ISO 15765-2 and 15765-4.

The API libraries 210 may assist in enabling over-the-air firmware updates of the vehicle controller 150 and the vehicle component controllers 200, as described further herein. The APIs 210 may also assist in enabling rapid-deployment of vehicle-wide features. The APIs 210 may be used for implementing vehicle-wide feature logic and invoking corresponding services. This may be done, for example, in a client-server model as described above in which the vehicle controller 150 is responsible for the vehicle-wide feature implementation while the low-level capabilities of the feature are implemented within the vehicle component controllers 200 and invoked through the high-level API libraries 210 from the programming space of the vehicle controller 150. The API libraries 210 may map the high-level API calls to the low-level PDU API for sending out the UDS services over-the wire to the respective vehicle component controllers 200.

In some examples, an ODX language (e.g., OTX or Java) is used to implement the API libraries 210. In other examples, the C programming language is used to implement the API libraries 210. In an example in which the C programming language is used, a broad selection of open-source interface definition languages (IDLs) may be used to allow for C code generation.

In examples, to achieve the rapid-deployment aspect of a software-defined vehicle, service-oriented architecture tools, processes, metrics, and modeling are used. In examples, a language-independent model is incorporated with the service-oriented architecture tools, processes, and metrics to allow support of heterogenous systems—e.g., involving vehicle component controllers 200 from different manufacturers or suppliers that use different tools and languages.

In examples, the over-the-wire service capabilities discussed herein may be modeled via system-level software. In examples, the over-the-wire services involve the communication of data like in traditional ISO 11898-1, periodic 8-byte CAN communications but also include a command aspect (including parameters) that specifies what to do with data, which is contributed from ISO 14229-1. The command aspect allows these services to be modeled as procedure calls—i.e., a remote procedure call (RPC)—which are given in a syntax at a higher level of abstraction than the UDS-based over-the-wire communication format described above.

In an example, such as with a “thin API,” the over-the-wire UDS read and write-related services allow the “get” and “set” RPC API functions, respectively. Similarly, the InputOutputControlByIdentifier service can be used as a “set’ type of service and has the advantage of allowing a mask parameter to ignore certain parameters while setting others over a “composite” dataIdentifier that includes multiple parameters. For more generic services—e.g., of a “fat API”—the RoutineControl service may be used.

The language-independent code—which calls RPCs such as “get” and “set,” thus modeling the service-based feature logic—may be an interface definition language (IDL). Due to the RPC acting as an abstract stitching between the vehicle component controllers 200 and the vehicle controller 150, the IDL allows modeling of the feature logic across the entire system as well as abstracting above processor, network, and other hardware details. This enables early system-level feature modeling. Further, this enables Agile practices since the IDL is also software that can utilize the same general tools. Additionally, DevOps tools such as Continuous Integration/Continuous Deployment also enable the rapid deployment benefits for software-defined vehicles.

In an example, for translating the system-level IDL down to the over-the-wire representation, code generation is used to produce the code to be implemented on the vehicle controller 150 and the vehicle component controllers 200 associated with the feature implementation. In an example, an open-source code generation tool may be used to translate the IDL to the over-the-wire representation. For example, Franca IDL may be used due to its CommonAPI that allows compatibility between different IP-based middleware. In other examples, SOME/IP from AUTOSAR or gRPC may be used.

In examples, software engineering processes such as Agile, CI/CD/DevOps, CMMI, and the like may be used to achieve rapid deployment of new, more advanced features that involve advanced interactions between multiple vehicle component controllers and vehicle controllers across the vehicle network system. These processes may also enable the use of mature quality metrics (e.g., within a CMMI framework). This improves the traditional distributed network feature design of vehicles and may significantly decrease design cycles and costs. Further, DevOps further enables a greater confidence in the ability to extend the over-the-air update process, as described further herein, beyond simple calibrations, bug fixes, and security patches to the launching of new, vehicle-wide features that involve multiple vehicle component controllers.

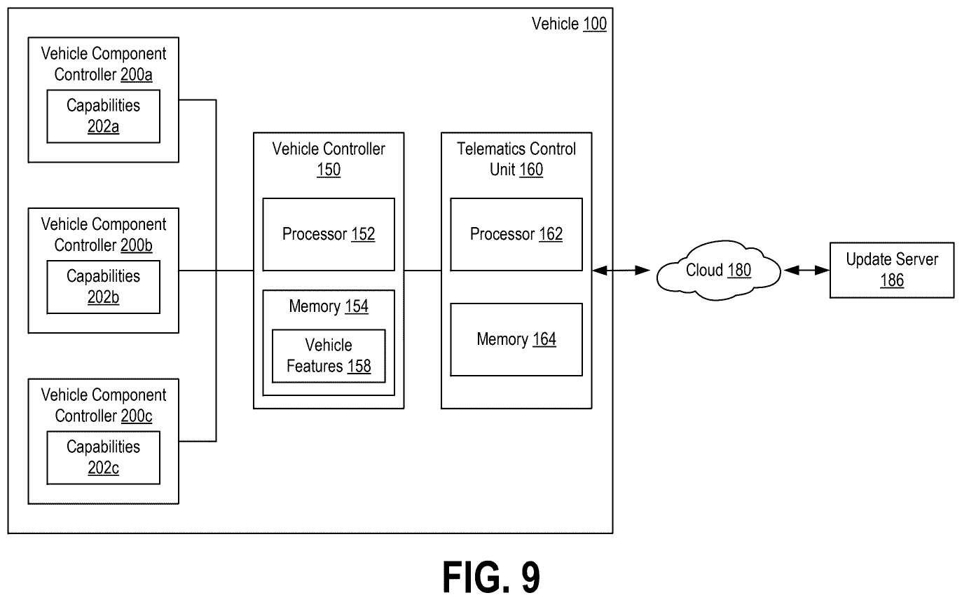

FIG. 9 illustrates an example of providing over-the-air updates for a vehicle 100. In the illustrated example, the vehicle is connected to an update server 186 through a cloud 180. In an example, a telematics control unit 160 facilitates the connection between the vehicle 100 and the update server 186.

In examples, the vehicle 100 may download updates to firmware or other software of the vehicle 100 from the update server 186. For example, when a new vehicle feature 158 is available for the vehicle 100, the telematics control unit 160 may connect to the update server 186 and download the update including the new vehicle feature 158. Using the discovery and communication framework described above, when the new vehicle feature 158 is downloaded, the vehicle controller 150 can control the vehicle component controllers 200 to implement the new vehicle feature 158. Similarly, in some examples, the updates downloaded from the update server 186 may update the software or firmware of the one or more of the vehicle component controllers 200.

The over-the-air update process plays a valuable role in the software-defined vehicle

DevOps process, allowing feature development iterations to be readily installed and tested on the vehicle 100. The over-the-air update process enables early system-level testing and other benefits, such as repeatability and built-in development metric tracking.

In an example, for reusability, the over-the-air firmware programming tool is based on the programming sequence specified in the UDS standard, ISO 14229-1, which is also the basis for other tools for programming the vehicle component controllers 200—specifically, within the diagnostic tool and the end-of-line tool. In examples, the same base code is used between the over-the-air programming tool, the diagnostic tool, and the end-of-line tool. These tools may also use the same service API programming library as used for the RPC programming space described above.

In an example, utilizing a 29-bit CAN ID—via ISO 11898-1—with a normal fixed addressing format—via ISO 15765-4—containing an 8-bit “source address field”—e.g., for the vehicle component controllers 200 and the vehicle controller 150—allows a parameterizable way to accomplish code reusability. For example, as long as the vehicle component controllers 200 do not restrict flash from a single specific source address (e.g., a diagnostic tool) but allow it to be reflashed from a device that successfully passes the Security Access UDS service, the telematics control unit 160 (or another over-the-air programming client) can reuse a common library (e.g., in cross-platform ANSI C) from the diagnostic tool or other similar device without conflicts on the CAN bus. In an example, this is achieved by setting the source address as a parameter in the reusable library which gets set to different, unique source addresses between clients.

In some examples, conditions for negative response codes may be made parameterizable to allow for different implementations between clients. For example, the negative response codes may be made more restrictive for the case of over-the-air programming to address safety risks that exist when programming the vehicle component controllers 200 and the vehicle controller 150 while the vehicle 100 is in an owner's possession—as opposed to the vehicle 100 being in a controlled dealership environment in which reflash is performed from a diagnostic tool.

Although the present disclosure has been described with reference to particular means, materials and examples, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A powersports vehicle, comprising:
a plurality of ground-engaging members;
a frame supported by the plurality of ground-engaging members;
a controller area network (CAN) bus of the powersports vehicle; and
a vehicle controller communicatively coupled to the CAN bus, vehicle controller including:
at least one processor; and
a memory storing data instructions which, when executed by the at least one processor, cause the vehicle controller to:
perform a discovery process to identify capabilities of a set of vehicle component controllers coupled to the CAN bus;
request data from a first vehicle component controller of the set of vehicle component controllers based on the identified capabilities of the first vehicle component controller;
receive the data from the first vehicle component controller via the CAN bus; and
in response to receiving the data, transmit a request to a second vehicle component controller of the set of vehicle component controllers via the CAN bus.

2. The powersports vehicle of claim 1, wherein to request data from the first vehicle component controller includes to:
transmit a subscription request to the first vehicle component controller via the CAN bus.

3. The powersports vehicle of claim 2, wherein the subscription request includes a request for periodic updates.

4. The powersports vehicle of claim 2, wherein the subscription request includes a request for an update in response to an occurrence of an event specified in the subscription request.

5. The powersports vehicle of claim 1, wherein execution of the data instructions further causes the vehicle controller:
receive, from an update service, an update including one or more vehicle features to be implemented at the powersports vehicle.

6. The powersports vehicle of claim 5, wherein the update includes software defined in an interface definition language.

7. The powersports vehicle of claim 6, wherein the software defined in the interface definition language is translated to a representation for communication over the CAN bus using code generation.

8. The powersports vehicle of claim 5, wherein each vehicle component controller of the set of vehicle component controllers is associated with an application programming interface library.

9. The powersports vehicle of claim 1, wherein to perform the discovery process to identify capabilities of the set of vehicle component controllers coupled to the CAN bus includes to:
transmit, to each vehicle component controller of the set of vehicle component controllers, a request for capabilities; and
receive, from each vehicle component controller of the set of vehicle component controllers, a response based on a capabilities document maintained by the vehicle component controller.

10. The powersports vehicle of claim 9, wherein the capabilities document includes an SAE J1979-DA document.

11. The powersports vehicle of claim 10, wherein the request for capabilities includes a request for a software version identifier and one or more supported coding identifiers.

12. The powersports vehicle of claim 1, wherein the discovery process is performed at start-up of the powersports vehicle.

13. A method for implementing features of a powersports vehicle, the method comprising:
performing a discovery process to identify capabilities of a set of vehicle component controllers coupled to a controller area network (CAN) bus of the powersports vehicle;
requesting data from a first vehicle component controller of the set of vehicle component controllers based on the identified capabilities of the first vehicle component controller;
receiving the data from the first vehicle component controller via the CAN bus; and
in response to receiving the data, transmitting a request to a second vehicle component controller of the set of vehicle component controllers via the CAN bus.

14. The method of claim 13, wherein performing the discovery process includes:
transmitting, to each vehicle component controller of the set of vehicle component controllers, a request for capabilities; and
receiving, from each vehicle component controller of the set of vehicle component controllers, a response based on a capabilities document maintained by the vehicle component controller.

15. The method of claim 13, wherein requesting data from a first vehicle component controller includes:
transmitting a subscription request to the first vehicle component controller via the CAN bus.

16. The method of claim 13, further comprising:
receiving, from an update service, an update including one or more vehicle features to be implemented at the powersports vehicle.

17. A non-transitory computer-readable medium having stored thereon data instructions that, when executed by one or more processors, cause the one or more processors to:
perform a discovery process to identify capabilities of a set of vehicle component controllers coupled to a controller area network (CAN) bus of a powersports vehicle;
request data from a first vehicle component controller of the set of vehicle component controllers based on the identified capabilities of the first vehicle component controller;
receive the data from the first vehicle component controller via the CAN bus; and
in response to receiving the data, transmit a request to a second vehicle component controller of the set of vehicle component controllers via the CAN bus.

18. The computer-readable medium of claim 17, wherein to perform the discovery process includes to:
transmit, to each vehicle component controller of the set of vehicle component controllers, a request for capabilities; and
receive, from each vehicle component controller of the set of vehicle component controllers, a response based on a capabilities document maintained by the vehicle component controller.

19. The computer-readable medium of claim 17, wherein to request data from a first vehicle component controller includes to:
transmit a subscription request to the first vehicle component controller via the CAN bus.

20. The computer-readable medium of claim 17, wherein execution of the data instructions further causes the one or more processors to:
receive, from an update service, an update including one or more vehicle features to be implemented at the powersports vehicle.
